(19) United States
(12) Patent Application Publication
(10) Pub. No.: US 2003/0040940 A1
(43) Pub. Date: Feb. 27, 2003

(54) Globally interoperable medical information system featuring a mini-compact disk, which serves as a personal health ID card and a secure key to access the system via the internet

(76) Inventor: Christian Nehammer, Estero, FL (US)

Correspondence Address: CHRISTIAN NEHAMMER, 22000 RED LAUREL LANE, ESTERO, FL, 33928, US

(21) Appl. No.: 10/126,999

(22) Filed: Apr. 22, 2002

(30) Foreign Application Priority Data
Aug. 27, 2001 (DE) 101 40 729-7

(51) Int. Cl. G06F 17/60

(52) U.S. Cl. 705/3

(57) ABSTRACT

A globally interoperable medical information system is provided whereby participants can access central medical files via the Internet. The system employs a specially programmed mini compact disk, which serves as the patient's personal Health-ID card and acts as a secure key to access and communicate with the central records database. CD-based encryption software enables files to be stored within the central servers in an encrypted version. Alternatively, the patients entire medical record can be encrypted and stored on the Health-ID card, and can then be decrypted and viewed (or encrypted and uploaded) by utilizing encryption software stored on the CD.

### BACKGROUND OF THE INVENTION

A secure, reliable information network system among healthcare providers, pharmacists and insurers does not exist. Physicians are often unable to access current, complete medical records because their patients commonly see several specialists, each maintaining separate medical files. This trend leads to a dispersion of numerous partial and irreconcilable medical records.

Inefficiencies in the healthcare system often result in expensive duplication of tests, procedures and exams. An effective medical information network would enhance a patient's ability to receive a proper diagnosis and quality care and could save thousands of lives per year.

The most widely acclaimed option for the next generation health card is based on “smart card” technology. Smart cards are the size of credit cards and utilize an embedded microprocessor. Smart cards communicate within dedicated networks and are not compatible with the Internet. Smart card networks have been developed within the banking industry, but not for purposes of transmitting healthcare information. Developing a worldwide smart card network would take years to complete and cost billions of dollars. Another obstacle for smart cards has arisen over the past last two years—new laws require that patients be given the opportunity to access their medical files, so smart card reader devices would have to be made available to all patients.

The present invention, the Global Med-ID System, achieves global interoperability via the Internet/Intranet. Healthcare providers and patients can access medical records though any personal computer equipped with a CD ROM or DVD drive and Internet access. Implementation of the system would be timely and cost effective, as no additional network must be developed.

### BRIEF SUMMARY OF THE INVENTION

The present invention, the Global Med-ID System, is comprised of two primary components. The first is a central database containing patient medical records and other healthcare information. The second is a mini compact disc, which serves as a personal Health-ID card and acts as a secure key to access the central database via the Internet.

This compact disk may be programmed to display the patient's emergency medical information, when inserted in the CD drive of a personal computer. After logging onto the Internet, the user is prompted to enter an authorization code in order to access a secure Intranet network. The user is then granted access to a patient's confidential medical records stored in a secure central server. Authorized healthcare providers may then review and update the patient's medical profile. Patients can view their medical records after entering a password, but are not permitted to upload critical medical data.

CD-based software encryption software can be downloaded to the user's computer, so that the user is able to encrypt files prior to being stored in central file servers, and then decrypted when later downloaded by the user.

Alternatively, the patient's entire medical file can be stored on the CD or DVD, and can be updated using read/write-capable CD or DVD drives installed at various healthcare provider locations.

### DETAILED DESCRIPTION OF THE INVENTION

The present invention, the Global Med-ID System, is an Internet/Intranet-based, globally interoperable medical information system comprised of two primary components. The first component is a central database containing patient medical records and other healthcare related data. The second is a mini compact disc, which serves as the patient's personal Health-ID card and acts as a secure key to access the central database via the Internet.

The compact disk is a device utilizing an opto-electronic storage medium, commonly referred to as a CD. Alternatively DVD's (Digital Video Disk) can be used with the Global Med-ID System. The two most common sizes of mini compact disks are 63×80 mm (two straight sides, two rounded sides) and 80 mm (round). A laser burner is used to write and permanently store software enabling the CD to communicate with a health records file server via the Internet and a secure Intranet. The Global Med-ID System will likely be comprised of multiple decentralized file servers—networked to provide global interoperability. In addition, the patient's emergency medical data may be burned on the CD or DVD so that it can be accessed during emergency situations without requiring an Internet connection. Alternatively, the patient's entire medical record can be stored on the CD or DVD and can be updated using read/write-capable CD or DVD drives installed at various healthcare provider locations—in such case their medical records are not stored in a central server and are not accessed via the Internet.

The CD allows the user to access continuously updated patient medical records using the following method:

First, a web page is burned onto a CD. When the CD in inserted in a CD drive, the computer recognizes the burned web page the same way it recognizes a web page posted on the Internet. That is, all functions that can be performed through web wages on the Internet can also be accomplished with a CD-based web page, including communicating with other web pages.

Secondly, a conventional web page is posted on the Internet. This web page displays “form fields” which can be activated to access data stored in the central file server, including patient medical files. These medical files are updated by healthcare professionals participating in the Global Med-ID System.

Thirdly, the CD is programmed (using HTML and/or XML coding) to load the browser installed on the computer and to then access the Internet-based web page. This procedure is performed automatically when the CD is inserted in the CD/DVD drive of a computer having Internet Access. Therefore, when the patient's medical file is accessed, the most recently updated version is displayed.

A distinction of the above-described method is that the CD-based web page can include a section which will be displayed on the computer screen as long as the CD is in the drive. This may present a desirable application for companies using CDs for advertising and marketing purposes. For example, the left column could permanently display certain information about the company, including the link to their website. The remainder of the screen would display the company's Internet-based web site. However, even if the user surfs away from the company's Internet webpage, the left column would remain as long as the CD is in the CD drive. Another advantage offered for purposes of promotional CDs is that the Internet-based web site is automatically imported to the display, rather than requiring the user to click on an Internet link. In addition, content can be selected from multiple Internet-based web pages and imported to the display simultaneously, so that several promoting companies can co-sponsor the promotional program.

The CD can be programmed to fulfill the role of a globally interoperable health card, using the existing Internet and Intranet technology. The CD is compatible with a standard CD-ROM or DVD drive, as equipped on most personal computers worldwide. Its CD-based web page can be read with MS Internet Explorer, as well as other commercial browsers—no further browser software is required for operation.

A variety of web-based medical software programs are available, which can be incorporated within the Global Med-ID System. No specific medical software program is being claimed as part of this patent application.

### EXPLANATION OF THE INVENTION BY EXAMPLE

In this scenario, an American citizen is involved in an automobile accident while traveling in Germany, and is rendered unconscious.

The emergency personnel find the patient's medical CD in his wallet and insert it in the CD drive of the laptop computer in their EMS vehicle. The CD discloses the patient's emergency medical data, such as blood type, allergies to medications, and emergency contact information.

Upon arriving at the hospital, the CD is inserted in a computer having Internet access. The ER physician is prompted to enter his secure German medical authorization code. After validation of the code, the physician is granted access to the patient's medical records, which have been stored in a central server in the United States. The physician treats the patient accordingly, and uploads new details regarding the patient's medical condition to the patient's medical file.

After returning home, the patient wishes to learn more about the treatment he received in Germany. He inserts his CD into his home computer and enters his password. After the central computer verifies the access code, he is permitted to review updated medical records, which reflect details of his recent treatment.

Had the patient elected to carry the type of CD that contained an encrypted version of this full medical record, the physician would access the files by inserting the CD in a computer with a CD drive. Special encryption software stored on the CD would be downloaded to the physician's computer to allow him to decrypt and view the medical records stored on the CD. Provided the physician had access to a read/write capable CD or DVD drive, he could encrypt information regarding the prescribed treatment, upload the data to the CD, and return the CD to the patient.

1. Claim for the invention of an internationally-interoperable Internet/Intranet-based medical information system, utilizing a central file server (or multiple decentralized, networked file servers) to store individual patients' medical records.

2. Claim according to 1, but with the addition of mini CDs (size ranging from 54×80 mm to 80×80 mm) issued to patients for the purpose of accessing medical record files, stored in the central server, via the Internet and/or an Intranet.

3. Claim according to 1 and 2 with the specific abilities of those mini CDs to request an access validation procedure prior to granting access to patient files stored in central server by authorized persons, utilizing advanced security technology, such as SSL server lines, encryption, and XML language codes.

4. Claim according to 1, 2, and 3 enabling patients and healthcare professionals to access patient's medical files from any personal computer worldwide, provided the computer has a CD drive and Internet access, thus creating a globally working medical information system.

5. Claim according to 1, 2, 3, and 4, also with the ability to permanently store patient medical data directly on the CD, such that this information can be viewed by inserting the CD in any personal computer with a CD drive, but without Internet access.

6. Claim according to 1, 2, 3, 4, and 5, also with the ability to transmit encrypted data along digital communication lines and store such encrypted data in the hosting computer

7. Claim according to 1, 2, 3, 4, 5 and 6, also with the ability to use CD/DVD-ROM software applications, which automatically open the computer's web browser, and then uses HTML and/or XML technology to automatically route the user to an Internet-based web page which provides access to the most recently updated files stored in a central server.

8. Claim according to 1, 2, 3, 4, 5, 6 and 7, also with the ability for the CD/DVD to contain encryption/decryption software that can be downloaded to the patient's or healthcare provider's computer so that they may then encrypt data prior to uploading to the central server and/or decrypt data to be downloaded their personal computers.

9. Claim according to 7, also with the ability to burn a web page onto the CD such that this CD-based web page is displayed on one portion of the screen and the Internet-based web page is displayed on the remaining portion of the screen, and the CD-based web page remains on the screen as long as the CD is in the CD drive, regardless as to whether the user browses away from the Internet-based web page.

10. Claim according to 7 and 9, also with the ability to automatically import content from multiple Internet-based web pages simultaneously.

11. Claim to store the patient's entire medical data directly on a read/write CD or DVD, such that the medical record can be updated using read/write-capable CD or DVD drives installed at various healthcare provider locations.

12. Claim according to 11, also with the ability to store encryption/decryption software on the CD or DVD, so that the user may download such software to their computers, and thereafter use the software to decrypt medical data downloaded from the CD and to encrypt medical data prior to uploading it to the CD.
